(19) United States
(12) Patent Application Publication
(10) Pub. No.: US 2026/0257694 A1
(43) Pub. Date: Sep. 3, 2026

(54) DRIVING ASSISTANCE APPARATUS, DRIVING ASSISTANCE METHOD, AND NON-TRANSITORY COMPUTER-READABLE STORAGE MEDIUM

(71) Applicant: HONDA MOTOR CO., LTD., Tokyo (JP)

(72) Inventors: Kiri YOSHIDA, Wako-shi (JP); Kohei MATSUDA, Wako-shi (JP); Kenjiro TORII, Wako-shi (JP); Shigenobu SAIGUSA, Wako-shi (JP); Youngjun AN, Tokyo (JP)

(21) Appl. No.: 19/675,795

(22) Filed: May 13, 2026

Related U.S. Application Data
(63) Continuation of application No. PCT/JP2024/040038, filed on Nov. 11, 2024.

(30) Foreign Application Priority Data
Nov. 17, 2023 (JP) 2023-196124

(51) Int. Cl. B60W 50/14; B60W 30/18

(52) U.S. Cl. CPC B60W 50/14; B60W 30/18163; B60W 2050/146; B60W 2420/403; B60W 2420/54; B60W 2552/10; B60W 2556/10; B60W 2720/10; B60W 2720/106

(57) ABSTRACT

A recognition unit recognizes a surrounding situation of a mobile unit. A determination unit determines whether the mobile unit is traveling in an acceleration section or a merging section of a merging lane when the mobile unit changes lanes from the merging lane to a receiving lane based on the recognized surrounding situation. A control unit, when it is determined that the mobile unit is traveling in the acceleration section, causes a notification device installed in the mobile unit to execute merging assistance related to acceleration, and when it is determined that the mobile unit is traveling in the merging section, causes the notification device to execute merging assistance for encouraging confirmation of a situation of the receiving lane, and suppresses the merging assistance related to acceleration as compared with a case where it is determined that the mobile unit is traveling in the acceleration section.

### CROSS-REFERENCE TO RELATED APPLICATION(S)

This application is a continuation of International Patent Application No. PCT/JP2024/040038 filed on November 11, 2024, which claims priority to and the benefit of Japanese Patent Application No. 2023-196124 filed on November 17, 2023, the entire disclosures of which are incorporated herein by reference.

### BACKGROUND OF THE INVENTION

### FIELD OF THE INVENTION

The present invention relates to a driving assistance apparatus, a driving assistance method, and a non-transitory computer-readable storage medium.

### DESCRIPTION OF THE RELATED ART

There is a technology for assisting vehicles in changing lanes. For example, Japanese Patent Laid-Open No. 2007-296978 discloses a technology for executing driving assistance processing based on a target driving behavior defined in each of a plurality of sections of a merging lane in order to merge a vehicle from the merging lane to the main roadway.

When a notification is given to the user for merging assistance, it is desirable to reduce a load on the user due to the notification.

### SUMMARY OF THE INVENTION

Therefore, an embodiment of the present invention provides a driving assistance apparatus that performs notification suitable for the acceleration section and the merging section while reducing the annoyance of the notification by display in the merging assistance.

According to one embodiment of the present disclosure, a driving assistance apparatus comprises: a recognition unit configured to recognize a surrounding situation of a mobile unit; a determination unit configured to determine whether the mobile unit is traveling in an acceleration section or a merging section of a merging lane when the mobile unit changes lanes from the merging lane to a receiving lane based on the recognized surrounding situation; and a control unit configured to when it is determined that the mobile unit is traveling in the acceleration section, cause a notification device installed in the mobile unit to execute merging assistance related to acceleration, and when it is determined that the mobile unit is traveling in the merging section, cause the notification device to execute merging assistance for encouraging confirmation of a situation of the receiving lane, and suppress the merging assistance related to acceleration as compared with a case where it is determined that the mobile unit is traveling in the acceleration section.

Further features of the present invention will become apparent from the following description of exemplary embodiments with reference to the attached drawings.

### BRIEF DESCRIPTION OF THE DRAWINGS

FIG. 1 is a block diagram illustrating an example of the configuration of a vehicle M including a driving assistance apparatus;

FIG. 2 illustrates the determination of a merging assistance section;

FIG. 3A and

FIG. 3B illustrate display of an image that changes in order from bottom to top;

FIG. 4 illustrates an example of merging assistance in an acceleration section;

FIG. 5 illustrates another example of merging assistance in the acceleration section;

FIG. 6 illustrates still another example of merging assistance in the acceleration section;

FIG. 7 illustrates yet another example of merging assistance in the merging section;

FIG. 8 is a flowchart illustrating an example of processing by the driving assistance apparatus according to a first embodiment; and

FIG. 9 is a flowchart illustrating an example of processing by the driving assistance apparatus according to a second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

A driving assistance apparatus according to an embodiment of the present invention recognizes the surrounding situation of the mobile unit, and determines whether the mobile unit is traveling in an acceleration section or a merging section of a merging lane when the mobile unit changes lanes from the merging lane to the receiving lane on the basis of the recognized surrounding situation. Next, in a case where it is determined that the mobile unit is traveling in the acceleration section, the driving assistance apparatus causes the notification device installed in the mobile unit to execute merging assistance related to acceleration, and in a case where it is determined that the mobile unit is traveling in the merging section, the driving assistance apparatus causes the notification device to execute merging assistance for encouraging confirmation of the situation of the receiving lane, and suppresses the merging assistance related to acceleration as compared with the case where it is determined that the mobile unit is traveling in the acceleration section.

The driving assistance apparatus according to the present embodiment is a vehicle-mounted device (ECU) mounted in a vehicle that is a mobile unit, and can control the vehicle according to each processing result, but may be a mobile terminal, a server, or the like as long as similar operation is possible, and is not limited thereto. The mobile unit according to the present embodiment refers to a structure that is autonomously movable by its own drive mechanism, such as a vehicle (four-wheeled or two-wheeled vehicle), a micro mobility vehicle, or an autonomous walking robot. Furthermore, in the following description, the mobile unit is assumed to be a vehicle moving on the ground.

### System

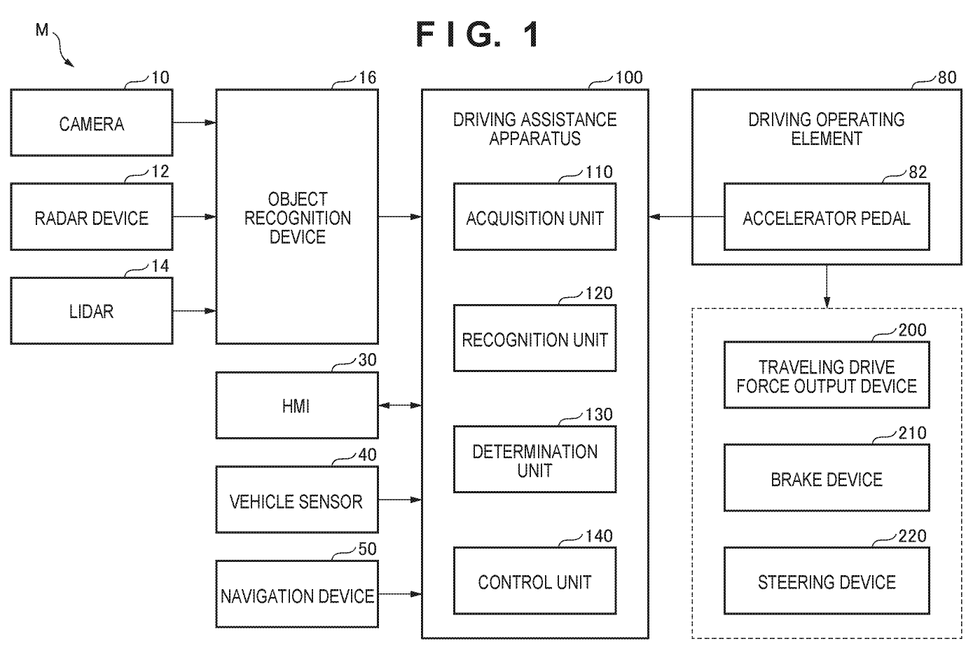

FIG. 1 is a block diagram illustrating an example of the hardware configuration of a vehicle M in which a driving assistance apparatus 100 according to the present embodiment is mounted. In FIG. 1, the vehicle M includes a camera 10, a radar device 12, a LiDAR 14, an object recognition device 16, a human machine interface (HMI) 30, a vehicle sensor 40, a driving operating element 80, a driving assistance apparatus 100, a traveling drive force output device 200, a brake device 210, and a steering device 220. The components of the vehicle M are connected to each other by a multiplex communication line such as a controller area network (CAN) communication line, a serial communication line, a radio communication network, or the like so as to be capable of sending and receiving information to and from each other. The configuration illustrated in FIG. 1 is an example, and part of the configuration may be omitted, or another configuration may be added.

The camera 10 is, for example, a digital camera using a solid-state imaging device such as a charge-coupled device (CCD) or a complementary metal oxide semiconductor (CMOS). The camera 10 is attached to any part of the vehicle M. When capturing an image of an area in front of the vehicle M, the camera 10 is attached to the top of a front windshield, the back of a room mirror, or the like. The camera 10 periodically and repeatedly captures images of an area around the vehicle M, for example. The camera 10 may be a stereo camera.

The radar device 12 emits radio waves such as millimeter waves to an area around the vehicle M, and detects the radio waves (reflected waves) reflected by an object to detect at least the position (distance and azimuth) of the object. The radar device 12 is attached to any part of the vehicle M. The radar device 12 may detect the position and speed of the object by a frequency modulated continuous wave (FM-CW) method.

The LiDAR 14 irradiates an area around the vehicle M with light (or electromagnetic waves having wavelengths close to light) and measures the scattered light. The LiDAR 14 detects the distance to a target on the basis of the time between light emission and light reception. The irradiated light is, for example, pulsed laser light. The LiDAR 14 is attached to any part of the vehicle M.

The object recognition device 16 performs sensor fusion processing on the detection results by some or all of the camera 10, the radar device 12, and the LiDAR 14 to recognize the position, type, speed, or the like of the object. The object recognition device 16 outputs the recognition results to the driving assistance apparatus 100. The object recognition device 16 may output the detection results of the camera 10, the radar device 12, and the LiDAR 14 to the driving assistance apparatus 100 as they are. Alternatively, the object recognition device 16 may be omitted.

The HMI 30 presents various types of information to an occupant of the vehicle M and receives input operations by the occupant. The HMI 30 includes various display devices, speakers, buzzers, vibration generators (vibrators), touch panels, switches, keys, or the like. The HMI 30 is an example of a “notification device”. As described above, in the present embodiment, since the driving assistance apparatus 100 is a vehicle-mounted device, the HMI 30 is a vehicle-mounted display device or the like. For example, if the driving assistance apparatus 100 is a mobile terminal (not illustrated) such as a smartphone carried by the user, the HMI 30 may be the display, speaker, or the like of such a mobile terminal. In addition to the vehicle-mounted display device and speaker, notification such as vibration by the mobile terminal may also be made at the same time. Furthermore, the notification device and the mobile terminal may be connected in a wired or wireless manner, and notification (for example, notification by image or notification by audio) performed by the notification device may also be performed in the mobile terminal.

The vehicle sensor 40 includes a vehicle speed sensor for detecting the speed of the vehicle M, an acceleration sensor for detecting acceleration, a yaw rate sensor for detecting angular velocity around a vertical axis, an azimuth sensor for detecting the orientation of the vehicle M, and the like.

A navigation device 50 has, for example, a global navigation satellite system (GNSS) receiver, a guidance controller, a storage unit storing map information, and the like. The GNSS receiver identifies the position of the vehicle M on the basis of signals received from GNSS satellites. The position of the vehicle M may be identified or supplemented by an inertial navigation system (INS) utilizing the output of the vehicle sensor 40. For example, the guidance controller determines a route from the position of the vehicle M identified by the GNSS receiver (or any input position) to a destination input by the occupant by referring to the map information, and causes the HMI 30 to output guidance information so that the vehicle M travels along the route. The map information is, for example, information in which road shapes are represented by links indicating roads and nodes connected by the links. The map information may include curvatures of roads, information of point of interest (POI), or the like. The navigation device 50 may transmit the current position and the destination of the vehicle M to a navigation server via a communication device and acquire a route from the navigation server.

The driving operating element 80 includes, for example, an accelerator pedal 82, a brake pedal, a steering wheel, a shift lever, and other operating elements. The accelerator pedal 82 is an example of an acceleration operating element. A sensor for detecting the amount of operation or the presence or absence of an operation is attached to the driving operating element 80, and the detection results thereof are output to some or all of the traveling drive force output device 200, the brake device 210, and the steering device 220.

The traveling drive force output device 200 outputs traveling drive force (torque) for the vehicle to travel to drive wheels. The traveling drive force output device 200 includes, for example, a combination of an internal combustion engine, an electric motor, a transmission, and the like, and an electronic control unit (ECU) that controls these components. The ECU controls the above configuration in accordance with information input from the driving assistance apparatus 100 or information input from the driving operating element 80.

The brake device 210 includes, for example, a brake caliper, a cylinder that transmits hydraulic pressure to the brake caliper, an electric motor that causes the cylinder to generate hydraulic pressure, and an ECU. The ECU controls the electric motor in accordance with the information input from the driving assistance apparatus 100 or from the driving operating element 80 so that the brake torque corresponding to a braking operation is output to each wheel. The brake device 210 may include a mechanism, as a backup, in which the hydraulic pressure generated by an operation of the brake pedal included in the driving operating element 80 is transmitted to the cylinder via a master cylinder. Note that the brake device 210 is not limited to the above-described configuration and may be an electronically-controlled hydraulic brake device in which an actuator is controlled in accordance with the information input from the driving assistance apparatus 100 and the hydraulic pressure of the master cylinder is transmitted to the cylinder.

The steering device 220 includes, for example, a steering ECU and an electric motor. The electric motor, for example, exerts a force on a rack-and-pinion mechanism to change the orientation of steered wheels. The steering ECU drives the electric motor to change the orientation of the steered wheels in accordance with the information input from the driving assistance apparatus 100 or from the driving operating element 80.

### Driving Assistance Apparatus

The driving assistance apparatus 100 recognizes the surrounding situation of the mobile unit, and determines whether the mobile unit is traveling in an acceleration section or a merging section of a merging lane when the mobile unit changes lanes from the merging lane to the receiving lane on the basis of the recognized surrounding situation. Next, in a case where it is determined that the mobile unit is traveling in the acceleration section, the driving assistance apparatus 100 causes the notification device installed in the mobile unit to execute merging assistance related to acceleration, and in a case where it is determined that the mobile unit is traveling in the merging section, the driving assistance apparatus 100 causes the notification device to execute merging assistance for encouraging confirmation of the situation of the receiving lane, and suppresses the merging assistance related to acceleration as compared with the case where it is determined that the mobile unit is traveling in the acceleration section. Hereinafter, the configuration of the driving assistance apparatus 100 and processing executed by the driving assistance apparatus 100 will be described with reference to FIGS. 1 to 8.

A recognition unit 120 among the components included in the driving assistance apparatus 100 may be in operation at all times, regardless of the situation that the vehicle M is in. The situation in which the vehicle M changes lanes from a merging lane to a receiving lane can be recognized, for example, by the recognition unit 120 checking the position of the vehicle M measured by the navigation device 50 against the map information.

The driving assistance apparatus 100 according to the present embodiment includes an acquisition unit 110, the recognition unit 120, a determination unit 130, and a control unit 140. These functional units are implemented by, for example, a hardware processor such as a central processing unit (CPU) executing a program (software). In addition, some or all of these components may be implemented by hardware (a circuit; including circuitry) such as a large-scale integration (LSI), an application specific integrated circuit (ASIC), a field-programmable gate array (FPGA), or a graphics processing unit (GPU), or may be implemented by software and hardware in cooperation. A program may be stored in advance in a storage device (a storage device including a non-transitory storage medium) such as the HDD or flash memory of the driving assistance apparatus 100, or may be stored in a detachable storage medium, such as a DVD or a CD-ROM, and installed in the HDD or flash memory of the driving assistance apparatus 100 when the storage medium (non-transitory storage medium) is attached to a drive device.

The acquisition unit 110 can acquire map information. The acquisition unit 110 may acquire the map information from the navigation device 50, or the navigation device 50 may be included in the driving assistance apparatus 100. The map information according to the present embodiment may be acquired on the basis of the position of the vehicle M, on the basis of user input, or on the basis of preset information. In the present embodiment, links contained in map information are identified as roads, and nodes contained in map information are identified as intersections. However, the intersections and roads on the map can be identified using any known technology that uses maps, and the method is not limited thereto.

The recognition unit 120 recognizes the state, such as the position, speed, and acceleration, of an object around the vehicle M on the basis of information input from the camera 10, the radar device 12, and the LiDAR 14 via the object recognition device 16. The position of the object is recognized as, for example, a position in absolute coordinates with the representative point of the vehicle M (center of gravity, drive shaft center, or the like) as the origin, and is used for control. The position of the object may be represented by a representative point, such as the center of gravity or a corner of the object, or by a represented region. The “state” of the object may include the acceleration, jerk, or the like of the object.

Furthermore, the recognition unit 120 recognizes, for example, a lane (travel lane) on which the vehicle M is traveling. For example, the recognition unit 120 recognizes the travel lane by comparing the pattern of lane markings (for example, an array of solid lines and dashed lines) acquired from the map information of the navigation device 50 with the pattern of lane markings around the vehicle M recognized from the image captured by the camera 10. Note that the recognition unit 120 may recognize the travel lane by recognizing not only the lane markings but also road boundaries including lane markings, road shoulders, curbs, median strips, guardrails, and the like. Furthermore, the recognition unit 120 may recognize the travel lane by recognizing an object existing on a road such as a road sign. In this recognition, the position of the vehicle M acquired from the navigation device 50 and the results of processing by the INS may be taken into consideration.

Here, for example, the determination unit 130 can determine whether or not the vehicle M is in a merging assistance section where merging assistance is executed, on the basis of the surrounding situation of the vehicle M recognized by the recognition unit 120. The merging assistance section according to the present embodiment includes a preparation section, an acceleration section, and a merging section.

The determination unit 130 according to the present embodiment can first estimate a merging point in the merge road where merging is to be performed, and determine whether or not the vehicle M is traveling in the merging assistance section on the basis of the estimated merging point and the current position of the vehicle M. Here, the determination unit 130 may determine that the vehicle M is traveling in the merging assistance section if the vehicle M is within a predetermined distance (for example, 3 km) from the estimated merging point, or may determine that the vehicle M is traveling in the merging assistance section if the expected time of arrival at the estimated merging point is within a predetermined time (for example, 5 minutes). Next, if it is determined that the vehicle M is traveling in the merging assistance section, the determination unit 130 determines, on the basis of the surrounding situation of the vehicle M, whether the vehicle M is traveling in the acceleration section of the merging lane, traveling in the merging section, or neither when the vehicle M changes lanes from the merging lane to the receiving lane. Here, the acceleration section refers to a section for the occupant of the vehicle M to perform acceleration (that is, depress the accelerator) in preparation for changing lanes from the merging lane to the receiving lane, and the merging section refers to a section for actually changing lanes from the merging lane to the receiving lane after the acceleration. In addition, if it is determined that the vehicle M is traveling in the merging assistance section and is neither traveling in the acceleration section nor in the merging section, it is determined that the vehicle M is traveling in the preparation section.

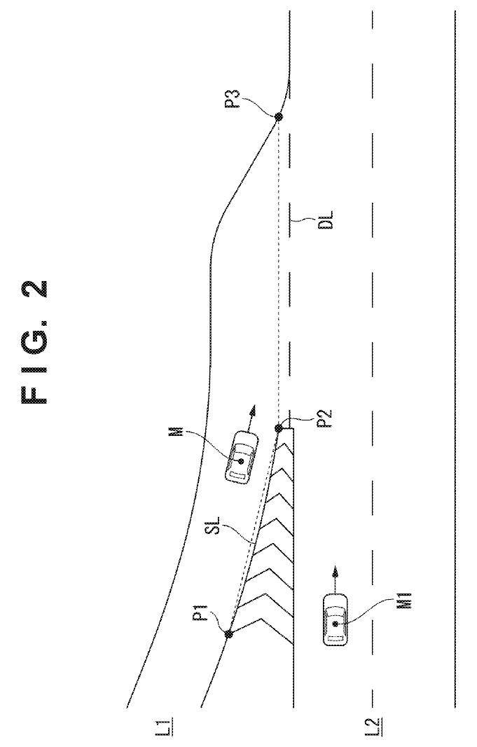

FIG. 2 illustrates determination processing executed by the determination unit 130. FIG. 2 illustrates, as an example, a situation in which the vehicle M merges from a merging lane L1 to a receiving lane L2. As described above, the situation in which the vehicle M merges from the merging lane L1 to the receiving lane L2 is recognized, for example, by the recognition unit 120 checking the position of the vehicle M measured by the navigation device 50 against the map information.

If at least one of a zebra zone (guiding zone) and a separation pole is recognized by the recognition unit 120, the determination unit 130 determines the first point where at least one of the zebra zone and the separation pole exists as the start point of the acceleration section (that is, the end point of the preparation section), and determines the last point where at least one of the zebra zone and the separation pole exists as the end point of the acceleration section. Therefore, the section from entry into the merging assistance section to point P1 is determined as the preparation section. If the vehicle M is present between the start point and the end point, the determination unit 130 determines that the vehicle M is traveling in the acceleration section. In the case of FIG. 2, the determination unit 130 determines the section between the point P1, which is the first point where the zebra zone exists, and point P2, which is the last point where the zebra zone exists, as the acceleration section.

If it is recognized by the recognition unit 120 that the vehicle M has passed through the end point of the acceleration section, the determination unit 130 determines that the vehicle M is traveling in the merging section. Furthermore, for example, if a point where the lane markings of the merging lane recognized by the recognition unit 120 change from solid lines to dashed lines is recognized, the determination unit 130 may determine that point as the start point of the merging section, and, when the vehicle M passes through the start point, determine that the vehicle M is traveling in the merging section. In the case of FIG. 2, using either method, the determination unit 130 determines that the vehicle M is traveling in the merging section when the vehicle M passes through the point P2.

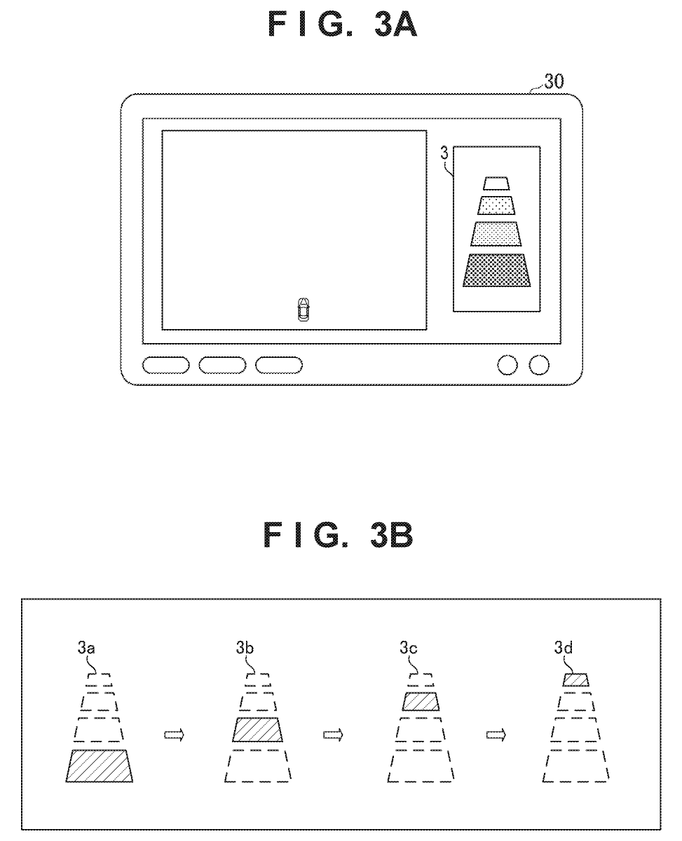

When it is determined that the vehicle M is traveling in the acceleration section, the control unit 140 causes the HMI 30 to execute merging assistance related to acceleration. Here, if the vehicle M is determined to be traveling in the acceleration section, the control unit 140 can cause the HMI 30 to execute merging assistance using image and sound. Hereinafter, with reference to FIGS. 3A and 3B, an example of display of an image that is displayed on the HMI 30 and changes in order from bottom to top will be described.

FIG. 3A is a diagram illustrating an example of display in merging assistance related to acceleration according to the present embodiment. In FIG. 3A, a moving image IM3 of merging assistance related to acceleration is displayed. The IM3 is an image including four blocks and is a moving image in which a color group with gradation flows from the near side to the far side. FIG. 3B is another example of the image group constituting the moving image IM3 and illustrates images IM3a to IM3d in which a plurality of blocks sequentially blinks in the traveling direction. The IM3a to IM3d are configured such that the blocks constituting an image group sequentially change from the bottom (blinking blocks flow) by sequentially displaying the blocks. By displaying shapes, a color gradation, or the like together with a audio notification instead of presenting instructions in text to the user, it is possible to easily understand the content of the audio instruction sensorially. Therefore, it is not necessary to gaze at the screen in order to determine the text, and it is possible to encourage the user to quickly understand the instruction content. Furthermore, with such a display, it is expected that the visual line of the user will be guided in the depth direction and the user will be prompted to view the front window, thereby encouraging the user to monitor the surroundings.

Here, in the merging assistance, the control unit 140 may perform different displays for the case of promoting acceleration (accelerator operation), the case of suppressing acceleration (not recommending accelerator operation), and the case of encouraging maintenance of speed. For example, the control unit 140 can set the color of the display in the merging assistance related to acceleration described above to a different color such as green in a case where acceleration is promoted, red in a case where acceleration is suppressed, and yellow in a case where maintenance of speed is encouraged. Furthermore, for example, in the display in the merging assistance related to acceleration described above, the control unit 140 can perform display such that an arrow in the vehicle front direction is displayed at the same time (for example, in the blinking block) in a case of promoting acceleration, an arrow in the vehicle rear direction is displayed at the same time in a case of suppressing acceleration, and such an arrow is not displayed in a case of encouraging maintenance of speed.

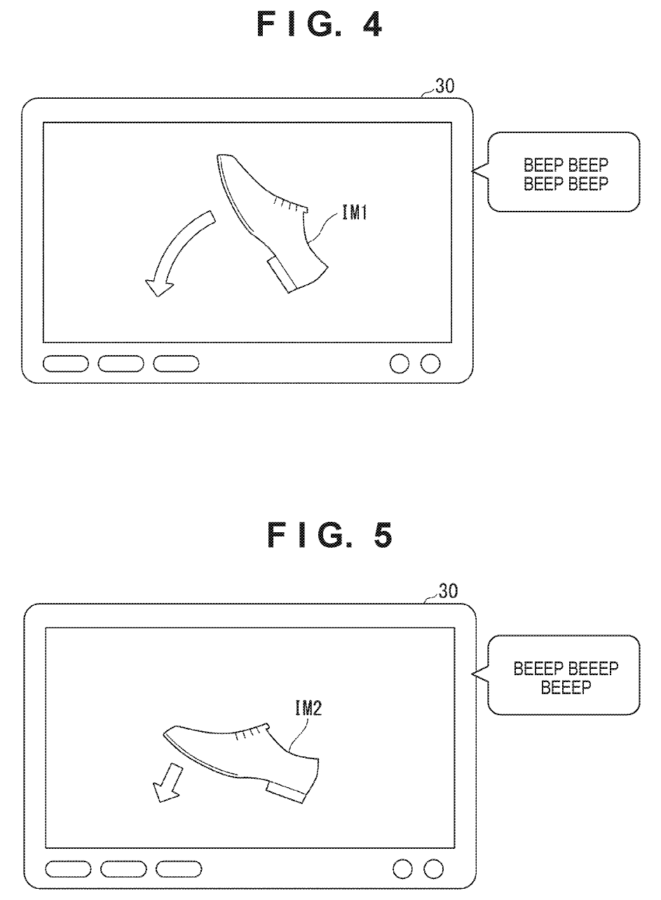

FIG. 4 illustrates a different example of merging assistance executed by the control unit 140 when the vehicle M travels in the acceleration section. As illustrated in FIG. 4, for example, upon determining that the risk to the vehicle M is low on the basis of the surrounding situation recognized by the recognition unit 120, the control unit 140 causes the HMI 30 to display an image IM1 that strongly encourages accelerator operation, together with the output of an electronic sound. Here, the risk is, for example, a time to collision (TTC) in the travel direction of another vehicle M1 with respect to the vehicle M, and the control unit 140 determines that the risk to the vehicle M is low, for example, if the TTC is equal to or greater than a first threshold value. If the vehicle M is traveling in the acceleration section, the occupant of the vehicle M generally tends to have plenty of time to check the screen of the HMI 30. Therefore, the control unit 140 causes the HMI 30 to execute driving assistance using both image and sound.

FIG. 5 illustrates another example of merging assistance executed by the control unit 140 when the vehicle M travels in the acceleration section. As illustrated in FIG. 5, for example, upon determining that the risk to the vehicle M is medium on the basis of the surrounding situation recognized by the recognition unit 120, the control unit 140 causes the HMI 30 to display an image IM2 that lightly encourages the occupant to operate the accelerator, together with the output of the electronic sound. For example, if the TTC is less than the first threshold value and equal to or greater than a second threshold value, the control unit 140 determines that the risk to the vehicle M is medium.

Note that the approach to accelerator operation recommendations based on the value of the TTC may be reversed between the case of FIG. 4 and the case of FIG. 5. More specifically, if the TTC is equal to or greater than the first threshold value, the control unit 140 may cause the HMI 30 to display the image IM2, which lightly encourages accelerator operation, together with the output of the electronic sound, and if the TTC is less than the first threshold value and equal to or greater than the second threshold value, the control unit 140 may cause the HMI 30 to display the image IM1, which strongly encourages the occupant to operate the accelerator, together with the output of the electronic sound.

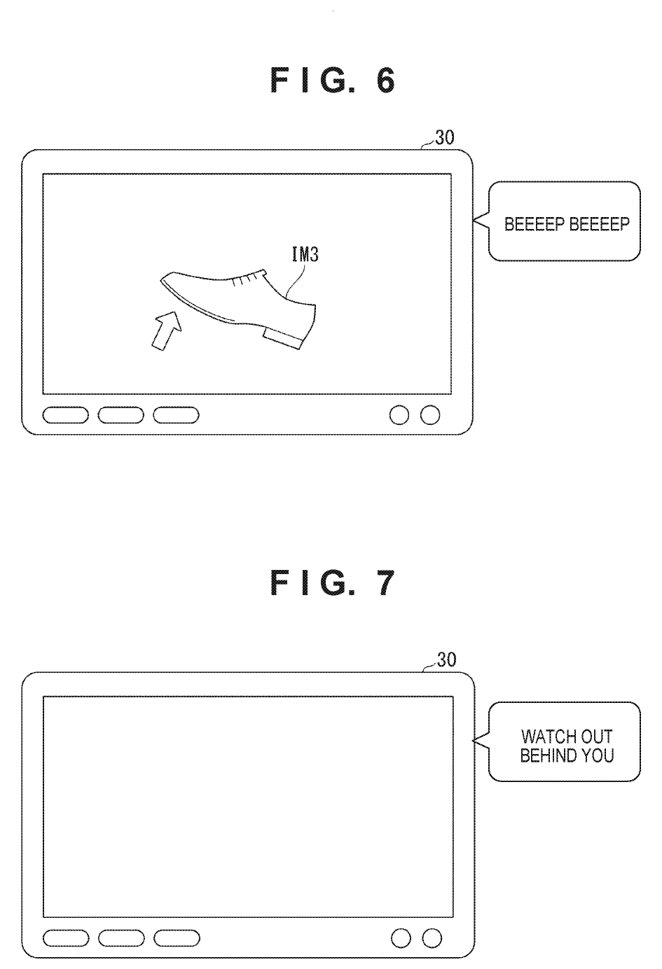

FIG. 6 illustrates another example of merging assistance executed by the control unit 140 when the vehicle M travels in the acceleration section. As illustrated in FIG. 6, for example, upon determining that the risk to the vehicle M is high on the basis of the surrounding situation recognized by the recognition unit 120, the control unit 140 causes the HMI 30 to display an image IM3 indicating that accelerator operation is not recommended, together with the output of the electronic sound. For example, if the TTC is less than the second threshold value, the control unit 140 determines that the risk to the vehicle M is high.

If it is determined that the vehicle M is traveling in the merging section, the control unit 140 causes the HMI 30 to suppress merging assistance related to acceleration as compared with the case where it is determined that the vehicle M is traveling in the acceleration section. Here, the control unit 140 can cause merging assistance by sound to be executed and suppress merging assistance by image. For example, if it is determined that the vehicle is traveling in the merging section, the control unit 140 may increase the transparency of the image displayed in the merging assistance, or may omit the merging assistance using an image.

In addition, the control unit 140 may determine whether or not to continue merging assistance related to acceleration when the vehicle M enters the merging section from the acceleration section. In that case, if it is determined that the merging assistance related to acceleration is to be continued, the merging assistance related to acceleration by sound is continued, and if it is determined that the merging assistance related to acceleration is not to be continued, the merging assistance related to acceleration by sound is stopped. For example, when the vehicle M enters the merging section from the acceleration section, the control unit 140 may determine whether the risk of the accelerator operation is low, medium, or high for the vehicle M as in the above-described example, and may determine to continue the merging assistance related to acceleration when the risk of the accelerator operation is determined to be low or medium.

FIG. 7 illustrates an example of merging assistance executed by the control unit 140 when the vehicle M travels in the merging section. As illustrated in FIG. 7, for example, upon determining that the risk to the vehicle M is medium on the basis of the surrounding situation recognized by the recognition unit 120, the control unit 140 causes the HMI 30 to output a sound in natural language such as “Watch out behind”. Meanwhile, upon determining that the risk to the vehicle M is high, the control unit 140 causes the HMI 30 to output a sound in natural language such as “Danger on the right”, “Danger on the left”, or “Danger behind”. If the vehicle M is traveling in the merging section, the occupant of the vehicle M generally tends to have little time to check the screen of the HMI 30. Therefore, the control unit 140 causes the HMI 30 to execute driving assistance using sound. In the present embodiment, notification by audio encouraging the user to monitor the surroundings, such as “Watch out behind” or “Danger on the right” (“direction in which to monitor” + “content of notification to user”), may be provided in the merging section.

The control unit 140 may perform notification by audio encouraging the user to monitor the surroundings in a case where merging assistance related to acceleration is not performed by audio. According to such processing, it is possible to avoid overlapping reproduction of the audio of the merging assistance related to acceleration and the audio encouraging monitoring of the surroundings. Alternatively, the control unit may perform merging assistance related to acceleration by using image, and may further perform notification for encouraging monitoring of the surroundings by using audio. As described above, by performing the notification related to acceleration and the notification related to monitoring of the surroundings by different modalities, it is possible to smoothly provide the notification without causing unnecessary confusion to the user.

As described above, if the vehicle M is traveling in the acceleration section and the occupant is assumed to have plenty of time to check the screen of the HMI 30, the control unit 140 places emphasis on acceleration assistance and causes the HMI 30 to execute driving assistance using both image and sound. Meanwhile, if the vehicle M is traveling in the merging section and the occupant is assumed to have little time to check the screen of the HMI 30, the control unit 140 places emphasis on alerting the occupant to the risk behind and causes the HMI 30 to execute driving assistance using sound and not to execute merging assistance using an image. As a result, it is possible to reduce the sense of incongruity felt by the occupant with respect to the mode of driving assistance when changing lanes.

Note that in the above description, if it is determined by the determination unit 130 that the vehicle M is traveling in the acceleration section, the control unit 140 causes the HMI 30 to execute driving assistance using both image and sound. In order to allow the occupant of the vehicle M to perform acceleration with plenty of margin, if the start point (point P1 in FIG. 2) of the acceleration section is recognized by the recognition unit 120, the control unit 140 may cause the HMI 30 to provide notification of the start of merging assistance a predetermined time before the vehicle M enters the acceleration section (that is, a predetermined time before the merging assistance is executed). Furthermore, if it is determined by the determination unit 130 that the vehicle M is traveling in the acceleration section, the control unit 140 may cause the HMI 30 to output instruction information related to the accelerator operation by sound to cause the occupant to recognize the start of merging assistance, and then output the instruction information by an image. As a result, it is possible to further reduce the sense of incongruity felt by the occupant with respect to the mode of driving assistance when changing lanes.

Alternatively, the control unit 140 may notify whether or not to perform the merging assistance when the vehicle M enters the preparation section. For example, the control unit 140 can cause the HMI 30 to display that the merge road is close and show a display for selecting whether or not to execute the merging assistance. Here, the HMI 30 accepts user input, and, if input requesting merging assistance is made, processing for merging assistance at the merge road is executed. If input requesting no merging assistance is made, it is recorded that merging assistance is not to be performed at the merge road. Note that, here, the description will be given assuming that the user performs input via a mechanical switch or a touch panel, but for example, input by voice recognition may be possible, and any other method of acquiring input by the user may be used.

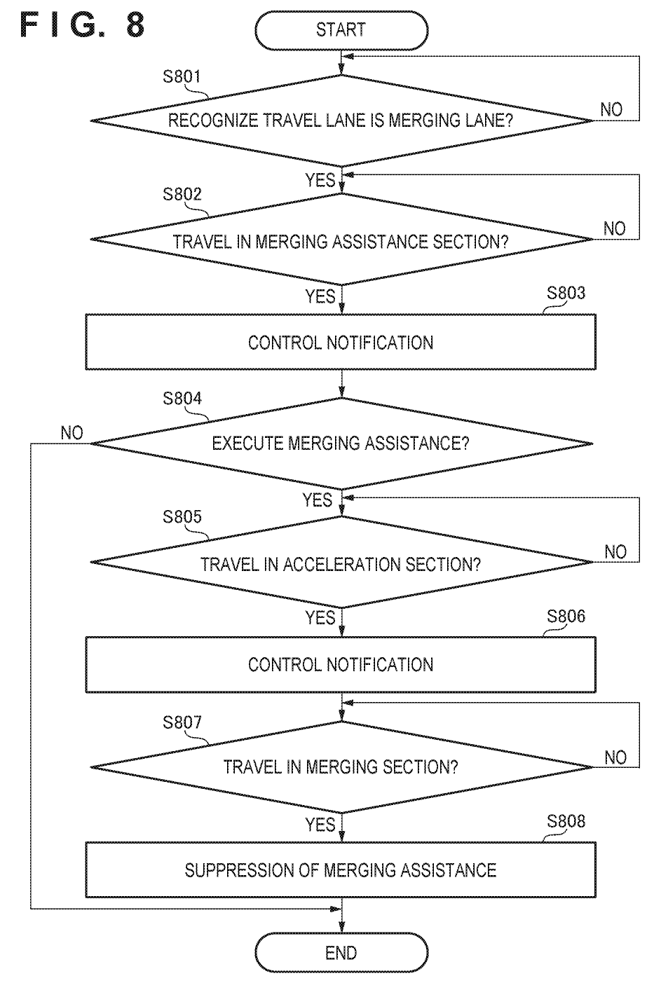

Next, a flow of processing executed by the driving assistance apparatus 100 according to the present embodiment will be described with reference to FIG. 8. FIG. 8 is a flowchart illustrating an example of driving assistance processing executed by the driving assistance apparatus 100. The processing illustrated in FIG. 8 is started, for example, at the startup of the vehicle M or the driving assistance apparatus 100, and is repeatedly executed in a predetermined cycle while the vehicle M is traveling.

In step S801, the recognition unit 120 checks the position of the vehicle M measured by the navigation device 50 against the map information to determine whether or not the travel lane is recognized as a merging lane. If the travel lane is not recognized as a merging lane, the recognition unit 120 executes the processing of step S801 again after a predetermined time. If the travel lane is recognized as a merging lane, the processing proceeds to step S802.

In step S802, the determination unit 130 determines whether or not the vehicle M is traveling in the merging assistance section. If it is determined that the vehicle M is not traveling in the merging assistance section, the determination unit 130 executes step S802 again after a predetermined time. If it is determined that the vehicle M is traveling in the merging assistance section, the processing proceeds to step S803.

In step S803, the control unit 140 causes the HMI 30 to display a confirmation as to whether or not to execute the merging assistance processing on the assumption that the vehicle M is traveling in the preparation section. In step S804, the control unit 140 determines whether or not to execute the merging assistance processing. If the merging assistance processing is to be executed, the processing proceeds to step S805, and otherwise, the processing ends. Here, it is assumed that the control unit 140 accepts user input, and executes the merging assistance processing if the input for executing the merging assistance processing is made.

In step S805, the determination unit 130 determines whether or not the vehicle M is traveling in the acceleration section, on the basis of the surrounding situation recognized by the recognition unit 120. If it is not determined that the vehicle M is traveling in the acceleration section, the determination unit 130 executes the processing of step S805 again after a predetermined time. If it is determined that the vehicle M is traveling in the acceleration section, the processing proceeds to step S806.

In step S806, the control unit 140 causes the HMI 30 to output a notification of merging assistance related to acceleration (here, the instruction information related to the accelerator operation is output by both image and sound). In step S807, the determination unit 130 determines whether or not the vehicle M is traveling in the merging section, on the basis of the surrounding situation recognized by the recognition unit 120. If it is not determined that the vehicle M is traveling in the merging section, the determination unit 130 executes the processing of step S807 again after a predetermined time. If it is determined that the vehicle M is traveling in the merging section, the processing proceeds to step S808.

In step S808, the control unit 140 causes the HMI 30 to suppress merging assistance (particularly, merging assistance by display of image) related to acceleration and ends the processing.

According to such a configuration, when the vehicle M changes lanes from the merging lane to the receiving lane, it is possible to execute normal merging assistance related to acceleration in a case where the vehicle M is traveling in the acceleration section, and it is possible to suppress merging assistance related to acceleration in a case where the vehicle M is traveling in the merging section. Therefore, when merging is performed, notification by the HMI can be reduced, and the user can be encouraged to focus on monitoring of the surroundings. In particular, by suppressing the merging assistance by display of image, it is possible to suppress the occupancy of the field of view by the image and to encourage the user to focus on monitoring of the surroundings.

### Second Embodiment

The driving assistance apparatus 100 according to the first embodiment suppresses the merging assistance related to acceleration when it is determined that the vehicle is traveling in the merging section, thereby reducing the annoyance of the merging assistance by display. A driving assistance apparatus according to the second embodiment performs control so as to suppress (for example, does not perform) the merging assistance by image on the basis of a use history of the merging assistance by the user, thereby reducing the annoyance of the merging assistance by display. Therefore, a driving assistance apparatus 100 according to the present embodiment recognizes the surrounding situation of a mobile unit, and causes a notification device installed in the mobile unit to execute merging assistance related to acceleration by image and sound when the mobile unit changes lanes from the merging lane to the receiving lane on the basis of the recognized surrounding situation. Next, a use history of the mobile unit including a use history of the merging assistance by the user of the mobile unit is acquired, and when the use history of the merging assistance satisfies a predetermined condition, the merging assistance is corrected so as to suppress the merging assistance by image in the merging assistance by a control unit.

The driving assistance apparatus 100 according to the present embodiment can execute determination of the travel section of a vehicle M on the basis of the surrounding situation of the vehicle M and merging assistance corresponding thereto similarly to the driving assistance apparatus according to the first embodiment, and thus redundant description will be omitted. Furthermore, since the driving assistance apparatus 100 according to the present embodiment has the same configuration as that of FIG. 1 of the first embodiment, redundant description will be omitted.

An acquisition unit 110 according to the present embodiment acquires a use history of a vehicle M including a use history of the merging assistance by the user. Here, as the use history of the vehicle M, the use (driving) history of the vehicle M by the user is stored in a database for each date (in a storage unit (not illustrated)). In addition, in the present embodiment, for each date or for each driving, information indicating whether or not the merging assistance processing using the driving assistance apparatus 100 according to the present embodiment is executed is attached to the use history of the vehicle M as the use history of the merging assistance.

For example, in a case where the user is sufficiently proficient using the merging assistance, it is conceivable to suppress the occupancy of the line of sight by the merging assistance by omitting the merging assistance by image. From such a viewpoint, for example, in a case where the number of times of use of the merging assistance is a predetermined threshold (for example, 20 times) or more, a control unit 140 can control the merging assistance processing so as not to perform notification of the merging assistance by image. Note that, here, the total number of times of use up to now is used as the number of times of use of the merging assistance, but for example, a reference period such as the recent two months may be provided, and the number of times of use within the reference period may be used. Furthermore, for example, in a case where the use frequency of the merging assistance is a predetermined threshold value or more, the control unit 140 can control the merging assistance processing so as not to perform notification of the merging assistance by image. For example, in a case where the use frequency of the merging assistance is 10 times or more per recent 2 months, it is possible to control the merging assistance processing so as not to perform notification of the merging assistance by image.

Furthermore, for example, in a case where the use period of the merging assistance is a predetermined threshold value or more, the control unit 140 can control the merging assistance processing so as not to perform notification of the merging assistance by image. Here, the use period of the merging assistance may be the sum of the number of days during which the merging assistance processing has been performed or the sum of the time during which the application performing the merging assistance processing has been executed.

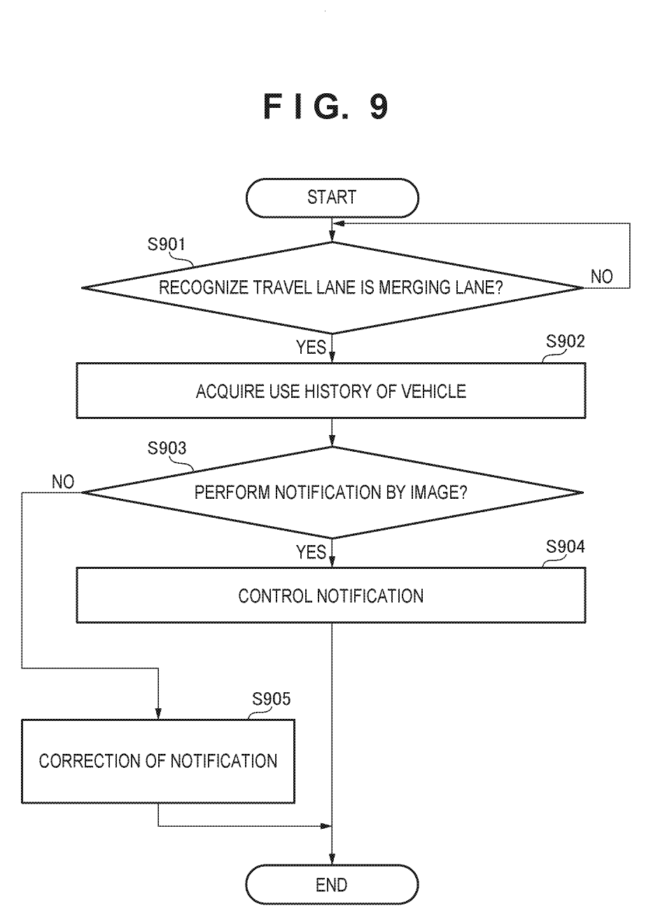

Next, a flow of processing executed by the driving assistance apparatus 100 according to the present embodiment will be described with reference to FIG. 9. FIG. 9 is a flowchart illustrating an example of driving assistance processing executed by the driving assistance apparatus 100. The processing illustrated in FIG. 9 is started, for example, at the startup of the vehicle M or the driving assistance apparatus 100, and is repeatedly executed in a predetermined cycle while the vehicle M is traveling.

In step S901, the recognition unit 120 checks the position of the vehicle M measured by the navigation device 50 against the map information to determine whether or not the travel lane is recognized as a merging lane. If the travel lane is not recognized as a merging lane, the recognition unit 120 executes the processing of step S901 again after a predetermined time. If the travel lane is recognized as a merging lane, the processing proceeds to step S902.

In step S902, the acquisition unit 110 acquires the use history of the vehicle M. In step S903, the determination unit 130 determines whether or not to perform notification of merging assistance by image on the basis of the acquired use history of the vehicle M. Here, it is assumed that the determination unit 130 determines whether or not the number of times of use of the merging assistance is a predetermined threshold value or more as a determination as to whether or not to perform notification of the merging assistance by image. If it is determined that the notification by image is to be performed, the processing proceeds to step S904, and otherwise, the processing proceeds to step S905.

In step S904, the control unit 140 outputs the notification of the merging assistance related to acceleration by both image and sound, and ends the processing. In step S905, the control unit 140 makes a correction so as not to perform notification of the merging assistance related to acceleration by image, causes the notification of the merging assistance to be output only by sound, and ends the processing.

According to such processing, it is possible to acquire a use history of the merging assistance by the user and correct the merging assistance so as not to perform the merging assistance by image in a case where the use history satisfies a predetermined condition. Therefore, in a case where it is considered that the user is proficient in the merging assistance according to the use history of the user, it is possible to stop occupying the field of view by the image and encourage the user to focus on monitoring of the surroundings.

### Summary of Embodiments

The above embodiments disclose at least the following driving assistance apparatus, driving assistance method, and program.

1. A driving assistance apparatus according to the above embodiment (for example, 100) comprises:
a recognition unit configured to recognize a surrounding situation of a mobile unit;
a determination unit configured to determine whether the mobile unit is traveling in an acceleration section or a merging section of a merging lane when the mobile unit changes lanes from the merging lane to a receiving lane based on the recognized surrounding situation; and
a control unit configured to
   when it is determined that the mobile unit is traveling in the acceleration section, cause a notification device installed in the mobile unit to execute merging assistance related to acceleration, and
   when it is determined that the mobile unit is traveling in the merging section, cause the notification device to execute merging assistance for encouraging confirmation of a situation of the receiving lane, and suppress the merging assistance related to acceleration as compared with a case where it is determined that the mobile unit is traveling in the acceleration section.

According to this embodiment, it is possible to reduce the annoyance of notification by display in merging assistance.

2. The driving assistance apparatus according to the above embodiment, further comprises a determination unit configured to determine whether or not to continue the merging assistance related to acceleration when a state in which it is determined that the mobile unit is traveling in the acceleration section shifts to a state in which it is determined that the mobile unit is traveling in the merging section, wherein

the control unit continues the merging assistance related to acceleration by sound when it is determined that the merging assistance related to acceleration is to be continued, and stops the merging assistance related to acceleration by sound when it is determined that the merging assistance related to acceleration is not to be continued.

According to this embodiment, it is possible to perform smooth merging by appropriately performing merging assistance according to the situation.

3. A driving assistance apparatus according to the above embodiment (for example, 100) comprises: a recognition unit configured to recognize a surrounding situation of a mobile unit; a control unit configured to cause a notification device installed in the mobile unit to execute merging assistance related to acceleration by an image and sound when the mobile unit changes lanes from a merging lane to a receiving lane based on the recognized surrounding situation; and an acquisition unit configured to acquire a use history of the mobile unit including a use history of the merging assistance by a user of the mobile unit; and a correction unit configured to correct the merging assistance so as not to perform the merging assistance by an image in the merging assistance by the control unit when the use history of the merging assistance satisfies a predetermined condition.

According to this embodiment, it is possible to reduce the annoyance of notification by display in the merging assistance on the basis of a use history of the merging assistance.

4. In the driving assistance apparatus according to the above embodiment, the correction unit corrects the merging assistance so as not to perform notification of the merging assistance by an image by the control unit when the number of times of use or the frequency of use of the merging assistance by the user is a predetermined threshold value or more.

According to this embodiment, in a case where the user is sufficiently proficient in the merging assistance, it is possible to omit the notification and encourage the user to focus on monitoring of the surroundings.

5. In the driving assistance apparatus according to the above embodiment, the correction unit corrects the merging assistance so as to suppress notification of the merging assistance by an image by the control unit when a use period of the merging assistance by the user is a predetermined threshold value or more.

According to this embodiment, in a case where the user is sufficiently proficient in the merging assistance, it is possible to omit the notification and encourage the user to focus on monitoring of the surroundings.

6. In the driving assistance apparatus according to the above embodiment, the merging assistance related to acceleration includes display of an image that changes in order from bottom to top.

According to this embodiment, it is possible to naturally bring the line of sight of the user close to the windshield to encourage monitoring of the surroundings.

7. In the driving assistance apparatus according to the above embodiment, the merging assistance related to acceleration is performed in different displays for a display for promoting acceleration of the mobile unit, a display for suppressing acceleration, and a display for maintaining speed.

According to this embodiment, it is possible to present the content of the merging assistance more easily recognizable for the user.

8. In the driving assistance apparatus of the above embodiment, the merging assistance related to acceleration is displayed in different colors for a display for promoting acceleration of the mobile unit, a display for suppressing acceleration, and a display for maintaining speed.

According to this embodiment, it is possible to present the content of the merging assistance more easily recognizable to the user by color.

9. In the driving assistance apparatus according to the above embodiment, the control unit performs merging assistance by audio related to monitoring of the surroundings by the mobile unit when the merging assistance related to acceleration is not performed by audio.

According to this embodiment, it is possible to avoid simultaneous reproduction of a notification related to acceleration and a notification related to monitoring of the surroundings.

10. In the driving assistance apparatus according to the above embodiment, the control unit performs the merging assistance related to acceleration by an image, and further performs merging assistance by audio related to monitoring of the surroundings by the mobile unit.

According to this embodiment, it is possible to perform notification related to acceleration and notification related to monitoring of the surroundings with different modalities.

11. A driving assistance method by a driving assistance apparatus according to the above embodiment (for example, 100) comprises: recognizing a surrounding situation of a mobile unit; determining whether the mobile unit is traveling in an acceleration section or a merging section of a merging lane when the mobile unit changes lanes from the merging lane to a receiving lane based on the recognized surrounding situation; and when it is determined that the mobile unit is traveling in the acceleration section, causing a notification device installed in the mobile unit to execute merging assistance related to acceleration, and when it is determined that the mobile unit is traveling in the merging section, causing the notification device to execute merging assistance for encouraging confirmation of a situation of the receiving lane, and suppressing the merging assistance related to acceleration as compared with a case where it is determined that the mobile unit is traveling in the acceleration section.

According to this embodiment, it is possible to reduce the annoyance of notification by display in merging assistance.

12. A driving assistance method by a driving assistance apparatus according to the above embodiment (for example, 100) comprises: recognizing a surrounding situation of a mobile unit; causing a notification device installed in the mobile unit to execute merging assistance related to acceleration by an image and sound when the mobile unit changes lanes from a merging lane to a receiving lane based on the recognized surrounding situation; and acquiring a use history of the mobile unit including a use history of the merging assistance by a user of the mobile unit; and correcting the merging assistance so as not to perform the merging assistance by an image in the merging assistance by the control unit when the use history of the merging assistance satisfies a predetermined condition.

According to this embodiment, it is possible to reduce the annoyance of notification by display in the merging assistance on the basis of a use history of the merging assistance.

13. A program according to the above embodiment causes a computer to perform a driving assistance method comprising: recognizing a surrounding situation of a mobile unit; determining whether the mobile unit is traveling in an acceleration section or a merging section of a merging lane when the mobile unit changes lanes from the merging lane to a receiving lane based on the recognized surrounding situation; and when it is determined that the mobile unit is traveling in the acceleration section, causing a notification device installed in the mobile unit to execute merging assistance related to acceleration, and when it is determined that the mobile unit is traveling in the merging section, causing the notification device to execute merging assistance for encouraging confirmation of a situation of the receiving lane, and suppressing the merging assistance related to acceleration as compared with a case where it is determined that the mobile unit is traveling in the acceleration section.

According to this embodiment, it is possible to reduce the annoyance of notification by display in merging assistance.

14. A program according to the above embodiment causes a computer to perform a driving assistance method comprising: recognizing a surrounding situation of a mobile unit; causing a notification device installed in the mobile unit to execute merging assistance related to acceleration by an image and sound when the mobile unit changes lanes from a merging lane to a receiving lane based on the recognized surrounding situation; and acquiring a use history of the mobile unit including a use history of the merging assistance by a user of the mobile unit; and correcting the merging assistance so as not to perform the merging assistance by an image in the merging assistance by the control unit when the use history of the merging assistance satisfies a predetermined condition.

According to this embodiment, it is possible to reduce the annoyance of notification by display in the merging assistance on the basis of a use history of the merging assistance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A driving assistance apparatus comprising:
a recognition unit configured to recognize a surrounding situation of a mobile unit;
a determination unit configured to determine whether the mobile unit is traveling in an acceleration section or a merging section of a merging lane when the mobile unit changes lanes from the merging lane to a receiving lane based on the recognized surrounding situation; and
a control unit configured to
when it is determined that the mobile unit is traveling in the acceleration section, cause a notification device installed in the mobile unit to execute merging assistance related to acceleration, and
when it is determined that the mobile unit is traveling in the merging section, cause the notification device to execute merging assistance for encouraging confirmation of a situation of the receiving lane, and suppress the merging assistance related to acceleration as compared with a case where it is determined that the mobile unit is traveling in the acceleration section.

2. The driving assistance apparatus according to claim 1, further comprising
the determination unit further determines whether or not to continue the merging assistance related to acceleration when a state in which it is determined that the mobile unit is traveling in the acceleration section shifts to a state in which it is determined that the mobile unit is traveling in the merging section, wherein
the control unit continues the merging assistance related to acceleration by sound when it is determined that the merging assistance related to acceleration is to be continued, and stops the merging assistance related to acceleration by sound when it is determined that the merging assistance related to acceleration is not to be continued.

3. A driving assistance apparatus comprising:
a recognition unit configured to recognize a surrounding situation of a mobile unit;
a control unit configured to cause a notification device installed in the mobile unit to execute merging assistance related to acceleration by an image and sound when the mobile unit changes lanes from a merging lane to a receiving lane based on the recognized surrounding situation; and
an acquisition unit configured to acquire a use history of the mobile unit including a use history of the merging assistance by a user of the mobile unit; and
a correction unit configured to correct the merging assistance so as not to perform the merging assistance by an image in the merging assistance by the control unit when the use history of the merging assistance satisfies a predetermined condition.

4. The driving assistance apparatus according to claim 3, wherein the correction unit corrects the merging assistance so as not to perform notification of the merging assistance by an image by the control unit when the number of times of use or the frequency of use of the merging assistance by the user is a predetermined threshold value or more.

5. The driving assistance apparatus according to claim 3, wherein the correction unit corrects the merging assistance so as to suppress notification of the merging assistance by an image by the control unit when a use period of the merging assistance by the user is a predetermined threshold value or more.

6. The driving assistance apparatus according to claim 1, wherein the merging assistance related to acceleration includes display of an image that changes in order from bottom to top.

7. The driving assistance apparatus according to claim 1, wherein the merging assistance related to acceleration is performed in different displays for a display for promoting acceleration of the mobile unit, a display for suppressing acceleration, and a display for maintaining speed.

8. The driving assistance apparatus according to claim 1, wherein the merging assistance related to acceleration is displayed in different colors for a display for promoting acceleration of the mobile unit, a display for suppressing acceleration, and a display for maintaining speed.

9. The driving assistance apparatus according to claim 1, wherein the control unit performs merging assistance by audio related to monitoring of the surroundings by the mobile unit when the merging assistance related to acceleration is not performed by audio.

10. The driving assistance apparatus according to claim 1, wherein the control unit performs the merging assistance related to acceleration by an image, and further performs merging assistance by audio related to monitoring of the surroundings by the mobile unit.

11. A driving assistance method comprising:
recognizing a surrounding situation of a mobile unit;
determining whether the mobile unit is traveling in an acceleration section or a merging section of a merging lane when the mobile unit changes lanes from the merging lane to a receiving lane based on the recognized surrounding situation; and
when it is determined that the mobile unit is traveling in the acceleration section, causing a notification device installed in the mobile unit to execute merging assistance related to acceleration, and
when it is determined that the mobile unit is traveling in the merging section, causing the notification device to execute merging assistance for encouraging confirmation of a situation of the receiving lane, and suppressing the merging assistance related to acceleration as compared with a case where it is determined that the mobile unit is traveling in the acceleration section.

12. A driving assistance method comprising:
recognizing a surrounding situation of a mobile unit;
causing a notification device installed in the mobile unit to execute merging assistance related to acceleration by an image and sound when the mobile unit changes lanes from a merging lane to a receiving lane based on the recognized surrounding situation; and
acquiring a use history of the mobile unit including a use history of the merging assistance by a user of the mobile unit; and
correcting the merging assistance so as not to perform the merging assistance by an image in the merging assistance by the control unit when the use history of the merging assistance satisfies a predetermined condition.

13. A non-transitory computer-readable storage medium storing a program that, when executed by a computer, causes the computer to perform a driving assistance method comprising:
recognizing a surrounding situation of a mobile unit;
determining whether the mobile unit is traveling in an acceleration section or a merging section of a merging lane when the mobile unit changes lanes from the merging lane to a receiving lane based on the recognized surrounding situation; and
when it is determined that the mobile unit is traveling in the acceleration section, causing a notification device installed in the mobile unit to execute merging assistance related to acceleration, and
when it is determined that the mobile unit is traveling in the merging section, causing the notification device to execute merging assistance for encouraging confirmation of a situation of the receiving lane, and suppressing the merging assistance related to acceleration as compared with a case where it is determined that the mobile unit is traveling in the acceleration section.

14. A non-transitory computer-readable storage medium storing a program that, when executed by a computer, causes the computer to perform a driving assistance method comprising:
recognizing a surrounding situation of a mobile unit;
causing a notification device installed in the mobile unit to execute merging assistance related to acceleration by an image and sound when the mobile unit changes lanes from a merging lane to a receiving lane based on the recognized surrounding situation; and
acquiring a use history of the mobile unit including a use history of the merging assistance by a user of the mobile unit; and
correcting the merging assistance so as not to perform the merging assistance by an image in the merging assistance by the control unit when the use
history of the merging assistance satisfies a predetermined condition.
